(19) United States
(12) Patent Application Publication
(10) Pub. No.: US 2022/0178252 A1
(43) Pub. Date: Jun. 9, 2022

(54) METHOD AND SYSTEM FOR PREDICTING PRODUCTION OF FRACTURED HORIZONTAL WELL IN SHALE GAS RESERVOIR

(71) Applicant: Southwest Petroleum University, Chengdu (CN)

(72) Inventors: Shuyong HU, Chengdu (CN); Wenhai HUANG, Chengdu (CN); Daqian RAO, Chengdu (CN); Jiayi ZHANG, Chengdu (CN); Tingting QIU, Chengdu (CN)

(21) Appl. No.: 17/114,880

(22) Filed: Dec. 8, 2020

(51) Int. Cl. E21B 49/08; G01V 99/00

(52) U.S. Cl. CPC E21B 49/087; E21B 2200/20; G01V 99/005

(57) ABSTRACT

The present disclosure relates to a method and system for predicting the production of a fractured horizontal well in a shale gas reservoir, and relates to the technical field of fractured horizontal wells. Considering the different diffusion modes of the matrix in different zones, the present disclosure uses Fick's First Law to describe the pseudo-steady-state diffusion of the matrix in the fracture network zone, Fick's Second Law to describe the unsteady-state diffusion of the matrix in the pure matrix zone, and Darcy's Law to describe the seepage in the fracture network. The present disclosure predicts the production of the fractured horizontal well in the shale gas reservoir under the conditions of matrix-microfracture coupling and hydraulically created fracture-microfracture coupling. The present disclosure improves the prediction accuracy of shale gas well production, and more accurately describes the actual flow law of the shale gas reservoir.

### TECHNICAL FIELD

The present disclosure relates to the technical field of fractured horizontal wells, in particular to a method and system for predicting the production of a fractured horizontal well in a shale gas reservoir.

### BACKGROUND

At present, many studies at home and abroad are based on the apparent permeability model that considers the multiple flow mechanisms of matrix pores to study the unsteady-state flow or pseudo-steady-state flow in the matrix and the Darcy flow or non-Darcy flow in the fracture and establish the unsteady-state or pseudo-steady-state productivity model of matrix-fracture coupling. In the nano-scale pores of the matrix, gas diffusion based on the concentration difference is an important component of gas flow. Shale gas diffusion can be described in two different ways: pseudo-steady-state diffusion and unsteady-state diffusion. In the hydraulically fractured zone and the pure matrix zone, the size of the matrix block is very different, and the diffusion mode of gas in the matrix is also different. Therefore, it is difficult for the model to describe the true gas flow by considering only the pseudo-steady-state diffusion or unsteady-state diffusion of the matrix, which leads to the low accuracy of the model in predicting the production of the shale gas well.

### SUMMARY

An objective of the present disclosure is to provide a method and system for predicting the production of a fractured horizontal well in a shale gas reservoir, so as to improve the prediction accuracy of the production of a shale gas well.

To achieve the above purpose, the present disclosure provides the following technical solutions.

A method for predicting the production of a fractured horizontal well in a shale gas reservoir includes:

dividing a fractured horizontal well to be predicted in a shale gas reservoir into five seepage zones according to a matrix block and a fracture network after hydraulic fracturing, where the five seepage zones include: hydraulically fractured zone I, fracture network zone II, pure matrix zone III, pure matrix zone IV and pure matrix zone V;

obtaining a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V;

obtaining a preset dimensionless transform relationship;

solving the zone V diffusion equation by the dimensionless transform relationship and Laplace transform to obtain a solution of the zone V diffusion equation;

solving the zone IV diffusion equation by the dimensionless transform relationship and Laplace transform to obtain a solution of the zone IV diffusion equation;

solving the zone III diffusion equation by the dimensionless transform relationship, Laplace transform and the solution of the zone V diffusion equation to obtain a solution of the zone III diffusion equation;

solving the zone II seepage differential equation by the dimensionless transform relationship, Laplace transform, the zone II diffusion equation, the solution of the zone IV diffusion equation and the solution of the zone III diffusion equation to obtain a solution of the zone II seepage differential equation;

solving the zone I seepage differential equation by the dimensionless transform relationship, Laplace transform and the solution of the zone II seepage differential equation to obtain a solution of the zone I seepage differential equation;

obtaining a first preset condition;

using the solution of the zone I seepage differential equation to obtain a bottom hole pseudo-pressure solution according to the first preset condition;

obtaining a dimensionless production solution by Duhamel's Principle according to the bottom hole pseudo-pressure solution; and

predicting the production of the fractured horizontal well in the shale gas reservoir by using a Stehfest numerical inversion method according to the dimensionless production solution.

A system for predicting the production of a fractured horizontal well in a shale gas reservoir includes:

a seepage zone dividing module, configured to divide a fractured horizontal well to be predicted in a shale gas reservoir into five seepage zones according to a matrix block and a fracture network after hydraulic fracturing, where the five seepage zones include: hydraulically fractured zone I, fracture network zone II, pure matrix zone III, pure matrix zone IV and pure matrix zone V;

a seepage zone equation obtaining module, configured to obtain a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V;

a dimensionless transform relationship obtaining module, configured to obtain a preset dimensionless transform relationship;

a zone V diffusion equation solving module, configured to solve the zone V diffusion equation by the dimensionless transform relationship and Laplace transform to obtain a solution of the zone V diffusion equation;

a zone IV diffusion equation solving module, configured to solve the zone IV diffusion equation by the dimensionless transform relationship and Laplace transform to obtain a solution of the zone IV diffusion equation;

a zone III diffusion equation solving module, configured to solve the zone III diffusion equation by the dimensionless transform relationship, Laplace transform and the solution of the zone V diffusion equation to obtain a solution of the zone III diffusion equation;

a zone II seepage differential equation solving module, configured to solve the zone II seepage differential equation by the dimensionless transform relationship, Laplace transform, the zone II diffusion equation, the solution of the zone IV diffusion equation and the solution of the zone III diffusion equation, to obtain a solution of the zone II seepage differential equation;

a zone I seepage differential equation solving module, configured to solve the zone I seepage differential equation by the dimensionless transform relationship, Laplace transform and the solution of the zone II seepage differential equation to obtain a solution of the zone I seepage differential equation;

a first preset condition obtaining module, configured to obtain a first preset condition;

a bottom hole pseudo-pressure solution obtaining module, configured to use the solution of the zone I seepage differential equation to obtain a bottom hole pseudo-pressure solution according to the first preset condition;

a dimensionless production solution obtaining module, configured to obtain a dimensionless production solution by Duhamel's Principle according to the bottom hole pseudo-pressure solution; and

a production predicting module, configured to predict the production of the fractured horizontal well in the shale gas reservoir by using a Stehfest numerical inversion method according to the dimensionless production solution.

According to the specific embodiments of the present disclosure, the present disclosure has the following technical effects.

The present disclosure provides a method and system for predicting the production of a fractured horizontal well in a shale gas reservoir. Considering the different diffusion modes of the matrix in different zones, the present disclosure uses Fick's First Law to describe the pseudo-steady-state diffusion of the matrix in the fracture network zone, Fick's Second Law to describe the unsteady-state diffusion of the matrix in the pure matrix zone, and Darcy's Law to describe the seepage in the fracture network. The present disclosure predicts the production of the fractured horizontal well in the shale gas reservoir under the conditions of matrix-microfracture coupling and hydraulically created fracture-microfracture coupling. The present disclosure improves the prediction accuracy of shale gas well production, more accurately describes the actual flow law of the shale gas reservoir, provides a new method for production decline analysis and prediction of the shale gas well, and provides theoretical basis and production suggestions for the beneficial development of the shale gas reservoir.

### BRIEF DESCRIPTION OF DRAWINGS

To describe the technical solutions in the embodiments of the disclosure or in the prior art more clearly, the accompanying drawings required for the embodiments are briefly described below. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of a method for predicting the production of a fractured horizontal well in a shale gas reservoir according to an embodiment of the present disclosure.

FIG. 2 is a simplified schematic diagram of a seepage pattern of the fractured horizontal well in the shale gas reservoir according to the embodiment of the present disclosure.

FIG. 3 is a schematic diagram of seepage zones of the fractured horizontal well in the shale gas reservoir according to the embodiment of the present disclosure.

FIG. 4 is a schematic diagram showing an effect of the size of a simulated reservoir volume (SRV) zone on the production according to the embodiment of the present disclosure.

FIG. 5 is a schematic diagram showing an effect of a wellbore storage coefficient on the production according to the embodiment of the present disclosure.

FIG. 6 is a schematic diagram showing an effect of a skin coefficient on the production according to the embodiment of the present disclosure.

FIG. 7 is a schematic diagram showing an effect of an inter-porosity flow coefficient on the production according to the embodiment of the present disclosure.

FIG. 8 is a schematic diagram showing an effect of fracture conductivity on the production according to the embodiment of the present disclosure.

FIG. 9 is a schematic diagram showing an effect absorbed gas and free gas in a matrix on the production according to the embodiment of the present disclosure.

### DETAILED DESCRIPTION

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts should fall within the protection scope of the present disclosure.

An objective of the present disclosure is to provide a method and system for predicting the production of a fractured horizontal well in a shale gas reservoir, so as to improve the prediction accuracy of the production of a shale gas well.

To make the foregoing objective, features, and advantages of the present disclosure clearer and more comprehensible, the present disclosure is further described in detail below with reference to the accompanying drawings and specific embodiments.

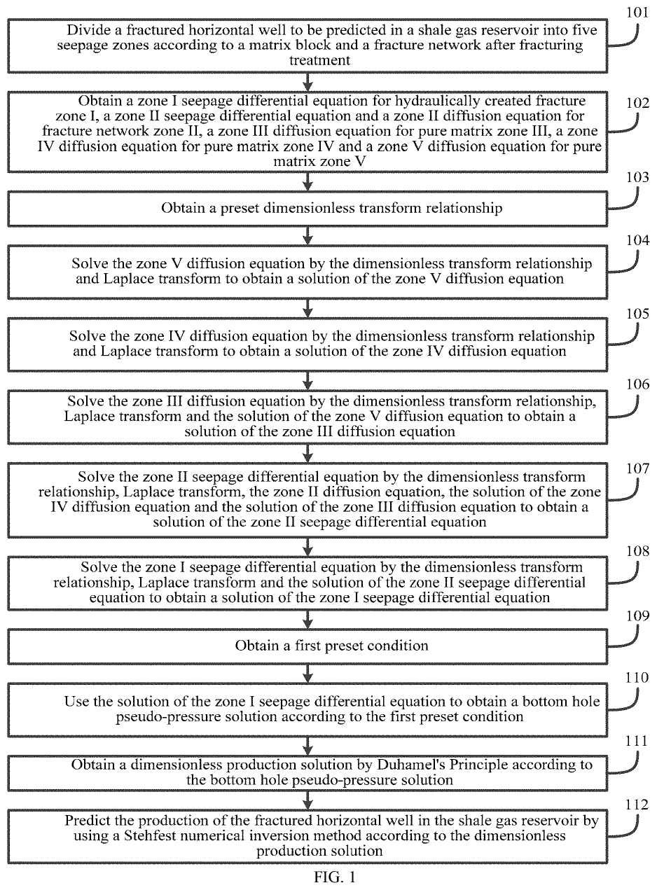

This embodiment provides a method for predicting the production of a fractured horizontal well in a shale gas reservoir. FIG. 1 shows a flowchart of the method for predicting the production of a fractured horizontal well in a shale gas reservoir according to the embodiment of the present disclosure. As shown in FIG. 1, the method for predicting the production of a fractured horizontal well in a shale gas reservoir includes:

Step 101: Divide a fractured horizontal well to be predicted in a shale gas reservoir into five seepage zones according to a matrix block and a fracture network after hydraulic fracturing, where the five seepage zones include: hydraulically fractured zone I, fracture network zone II, pure matrix zone III, pure matrix zone IV and pure matrix zone V.

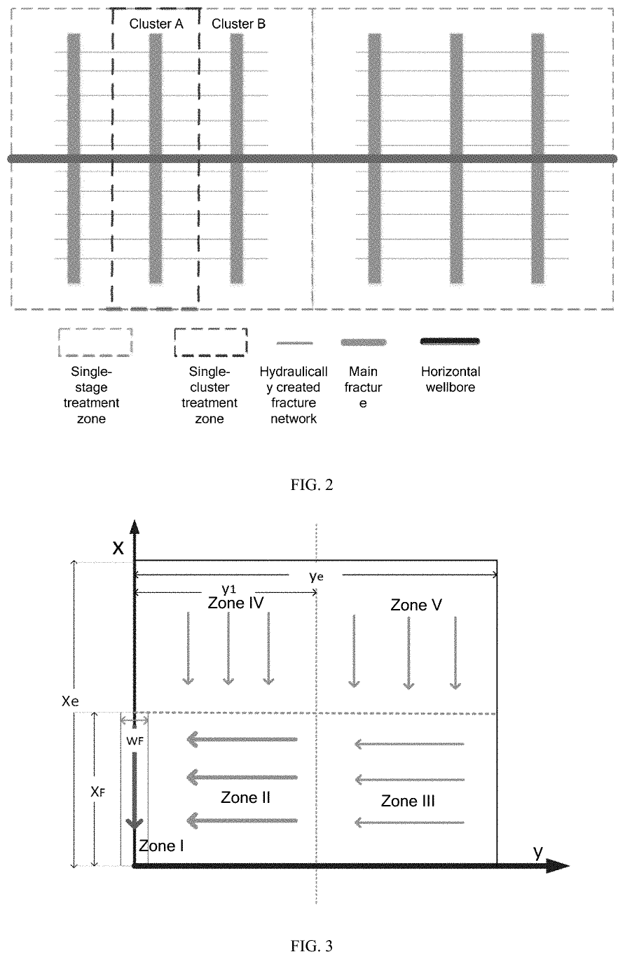

The shale reservoir has very low permeability, and it is believed that the effective discharge boundary after hydraulic fracturing is equal or close to the length of a hydraulically created fracture. Therefore, the fractured horizontal well in the shale gas reservoir can be simulated as a horizontal well with a rectangular drainage area. The rectangular drainage area of the horizontal well is composed of a fracture network divided by a matrix block. The pure matrix zone without being hydraulically fractured also contributes to the production of shale gas and cannot be ignored. The seepage pattern of the fractured horizontal well in the shale gas reservoir is shown in FIG. 2. A single-stage treatment zone consists of multiple single-cluster treatment zones. In FIG. 2, there are three single-cluster treatment zones in a single-stage treatment zone, and the single-cluster treatment zone is composed of a hydraulically fractured network and an untreated zone. A quarter of a fracture network (a single-cluster treatment zone) in FIG. 2 is taken as the research object to establish a five-linear-flow mathematical model. The five-linear-flow mathematical model includes five seepage zones: hydraulically fractured zone (zone I), fracture network zone (zone II), and pure matrix zones (zone III, zone IV and zone V), as shown in FIG. 3. The gas flows into an artificial fracture from a formation, and then flows into a wellbore along the fracture. In FIG. 3, the one-way arrow indicates a mass transfer direction (flow direction and diffusion direction) of the gas. In FIG. 3, the horizontal axis y indicates the direction of the horizontal wellbore; the vertical axis x indicates the direction of the hydraulically created fracture. yₑ indicates the width of the research object, which is one-half of the cluster spacing. y1 indicates the width of the fracture network zone (i.e. stimulated reservoir volume (SRV) zone). In FIG. 3, zone II is the SRV zone. xₑ is a distance from the boundary of the untreated zone to the horizontal wellbore (which can be obtained from microseismic monitoring). x_{F} is the length of the hydraulically created fracture in zone I. W_{F} is the width of the hydraulically created fracture, unit: m. The length of the hydraulically created fracture in zone I is equal to the length of those in zones II and III.

Assumptions are made for the five-linear flow mathematical model. (1) The reservoir is a closed reservoir of equal thickness and is always in an isothermal state during the mining process. (2) The gas flow in the fracture obeys the Darcy flow law, and is single-phase gas flow, ignoring the influence of gravity and capillary force. (3) The hydraulically created fractures are perpendicular to the wellbore, symmetrically and evenly distributed, with the same properties and characteristics. (4) The fracture network zone (SRV zone) has a fracture-pore medium, and the outside zones, that is, the zones out of the SRV zone, specifically, zone III, zone IV and zone V, all have a single porous medium with the same physical properties. (5) The gas reservoir is in equilibrium before exploitation, and the adsorbed gas and free shale gas are also in dynamic equilibrium.

Step 102: Obtain a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V.

Step 102 may specifically include:

After hydraulic fracturing, the main hydraulically created fracture in hydraulically fractured zone I is perpendicular to the horizontal wellbore, the fracture height is equal to the height of the reservoir, and the seepage direction is perpendicular to the wellbore direction. The fluid (gas source) in the hydraulically created fracture zone comes from the SRV zone, and there is no fluid supply by itself, that is, the source term q=0. Substituting Darcy's formula into the material balance equation leads to the zone I differential equation:

$$\frac{\partial ( {ϕ}_{1 F} {ρ}_{1 F} )}{\partial t} - ∇ ( {ρ}_{1 F} \frac{{k}_{1 F}}{μ} ∇ {p}_{1 F} ) = 0 \qquad ( 1 )$$

In Eq. (1), ϕ_{1,F} represents a fracture porosity in zone I; ρ_{1,F} represents a fracture gas density in zone I; t represents time; ∇ represents a gradient operator; k_{1F} represents fracture permeability in zone I; μ represents a gas viscosity of the fractured horizontal well in the shale gas reservoir; ∇ₚ_{_{1F}} represents a gradient operator of fracture pressure in zone I.

The shale matrix diffusion process is a process from unsteady-state diffusion to pseudo-steady-state diffusion. The matrix size in the SRV zone is relatively small (mostly on the order of meters in diameter), and the pressure drop generated by diffusion can quickly spread to the inside of the bedrock and enter a pseudo-steady state. Therefore, Fick's First Law is used to describe the diffusion process from the matrix in fracture network zone II to the fracture, to obtain the zone II diffusion equation:

$$\frac{\partial {V}_{m}}{\partial t} = σ {D}_{m} ( {V}_{E} - {V}_{m} ) \qquad ( 2 )$$

In the equation, Vₘ represents the total concentration of shale gas inside the matrix block, including the concentration of adsorbed phase and free phase; σ represents a matrix block shape factor; Dₘ represents a coefficient of shale gas diffusion inside the matrix block; V_{E} represents an apparent concentration of shale gas when the gas supply from the matrix block to the fracture network reaches equilibrium.

Vₘ is expressed by:

$${V}_{m} = \frac{{ϕ}_{m} {Z}_{s c} {T}_{s c}}{Z T {P}_{s c}} {p}_{m} + ( 1 - {ϕ}_{m} ) \frac{{p}_{m} {V}_{L}}{{p}_{m} + {p}_{L}} \qquad ( 3 )$$

V_{E} is expressed by:

$${V}_{E} = \frac{{φ}_{m} {Z}_{s c} {T}_{s c}}{Z T {P}_{s c}} {p}_{f} + ( 1 - {φ}_{m} ) \frac{{p}_{f} {V}_{L}}{{p}_{f} + {p}_{L}} \qquad ( 4 )$$

In the equations, ϕₘ represents a matrix porosity; Z_{sc} represents a gas compressibility under standard conditions; T_{sc} represents a temperature under standard conditions, 273.15k; Z represents a gas compressibility under gas reservoir conditions; T represents an actual temperature; P_{sc} represents a standard pressure, 1.01×10⁵ Pa; pₘ represents a matrix pressure; V_{L} represents a Langmuir volume; p_{L} represents a Langmuir pressure; and p_{f} represents a fracture pressure.

In fracture network zone II, the matrix supplies gas to the fracture, that is, the source term is q₂ₘ. According to Darcy's Law and the principle of material balance, the seepage differential equation of the fracture in zone II is:

$$\frac{\partial ( {ϕ}_{2 f} {ρ}_{2 f} )}{\partial t} - ∇ ( {ρ}_{2 f} \frac{{k}_{2 f}}{μ} ∇ {p}_{2 f} ) = - {ρ}_{g s c} {q}_{2 m} \qquad ( 5 )$$

In the equation, ϕ_{2ƒ} represents a fracture porosity in zone II; ρ_{2ƒ} represents a fracture gas density in zone II; k_{2ƒ} represents a fracture permeability in zone II; μ represents a gas viscosity of the fractured horizontal well in the shale gas reservoir; ρₚ_{_{2ƒ}} represents a gradient operator of fracture pressure in zone II; ρ_{gsc} represents a gas density under standard conditions; q₂ₘ represents the amount of gas supplied to the fracture by the matrix.

The fracturing treatment has little effect on pure matrix zone III, pure matrix zone IV and pure matrix zone V, so they are regarded as pure matrix zones. The matrix gas in zone III, zone IV and zone V is supplied to the fracture network in a diffusion manner. Assuming that Vₘ (x, y, z, t) is the gas concentration at a certain point in the matrix zone at a certain moment, x, y and z respectively represent the x direction, y direction and z direction in a three-dimensional (3D) Cartesian coordinate system of the fractured horizontal well in the shale gas reservoir. In this embodiment, there is no gas mass transfer in the z direction, which is quantitative and will not be considered in model establishment and solution. Due to the large size of the outer matrix zones, the diffusion in the matrix zone is considered to be unsteady-state diffusion. Vₘ (x, y, z, t) is a function of time and space. Therefore, Fick's Second Law is used to describe the diffusion process from the matrix to the fracture in zones III, IV and V, and the zone III diffusion equation, the zone IV diffusion equation and the zone V diffusion equation are uniformly written as:

$$\frac{\partial {V}_{m}}{\partial t} = {D}_{m} {∇}^{2} {V}_{m} \qquad ( 6 )$$

In the equation, ∇² is defined as the square of the gradient operator, meaning the second-order partial derivative of Vₘ to x and y.

Step 103: Obtain a preset dimensionless transform relationship. For the convenience of solving, dimensionless variables are defined, and the preset dimensionless transform relationships include:

Dimensionless pseudo-pressure:

$${ψ}_{ifD} = \frac{π {k}_{f} {hT}_{sc}}{{p}_{sc} {q}_{sc} T} ( {ψ}_{0} - {ψ}_{i} ) ;$$

dimensionless time:

$${t}_{D} = \frac{{η}_{f}}{{x}_{F}^{2}} t ;$$

dimensionless distance:

$${x}_{D} = \frac{x}{{x}_{f}} , {y}_{D} = \frac{y}{{x}_{f}} , {W}_{F D} = \frac{{W}_{F}}{{x}_{f}} ;$$

dimensionless conductivity factor:

$${η}_{F D} = \frac{{η}_{F}}{{η}_{f}} ,$$

where:

$${η}_{f} = \frac{{k}_{f}}{{ϕ}_{f} {c}_{f} μ} , {η}_{F} = \frac{{k}_{F}}{{ϕ}_{F} {c}_{F} μ} ;$$

dimensionless conductivity:

$${F}_{C D} = \frac{{k}_{F}}{{k}_{f}} \frac{{W}_{F}}{{x}_{F}} ;$$

dimensionless diffusion coefficient:

$${D}_{m D} = \frac{{D}_{m}}{{η}_{f}} ;$$

storage coefficient:

$$ω = \frac{2 π h}{{Z}_{s c} {q}_{s c}} {D}_{m} ;$$

inter-porosity flow coefficient:

$$λ = \frac{{x}_{F}^{2}}{{η}_{f}} σ {D}_{m} ;$$

dimensionless concentration: V_{ED}=V_{E}−Vᵢ; V_{mD}=Vₘ−Vᵢ.

In the above equations, ψ_{ifD} represents a dimensionless fracture pseudo-pressure of an i-th zone, where 1=1 represents zone I, i=2 represents zone II, i=3 represents zone III, i=4 represents zone IV, and i=5 represents V zone. There is no subscript i in the SRV model (zone II model). 7E represents the circumference ratio. k_{ƒ} represents the fracture permeability of zone II, unit: m². h represents the thickness of the formation, unit: m. q_{sc} represents the surface production of the horizontal well, unit: m³/s. ψ₀ represents the pseudo-pressure of the entire gas reservoir at an initial moment. ψᵢ represents the pseudo-pressure of the i-th zone at a certain moment. t_{D} represents a dimensionless time. η_{ƒ} represents a dimensionless conductivity factor. x_{F} represents the length of the hydraulically created fracture, unit: m. x_{D} represents a dimensionless variable x, where x represents a variable in the x direction in the 3D coordinate system. x_{f} represents the fracture length of zone II. y_{D} represents a dimensionless variable y, where y represents a variable in the y direction in the 3D coordinate system. W_{FD} represents a dimensionless width of the hydraulically created fracture. W_{F} represents the width of the hydraulically created fracture, unit: m. η_{FD} represents a dimensionless conductivity factor of the fracture in zone I. η_{F} represents the conductivity factor of the main fracture in zone I. η_{ƒ} represents the fracture conductivity factor of zone II. ϕ_{ƒ} represents the porosity of the fracture network. c_{ƒ} represents the compressibility of fracture zone II. k_{F} represents the permeability of zone I. ϕ_{F} represents the porosity of the hydraulically created fracture. c_{F} represents the compressibility of zone I, unit: 1/Pa F_{CD} represents a dimensionless conductivity. D_{mD} represents a dimensionless diffusion coefficient. Dₘ represents the diffusion coefficient, unit: m²/s. ω represents the storage coefficient. Dₘ represents the inter-porosity flow coefficient. V_{ED} represents a dimensionless apparent concentration of shale gas when the gas supply from the matrix block to the fracture network reaches equilibrium. Vᵢ represents an initial concentration of shale gas inside the matrix block. V_{mD} represents a dimensionless total concentration of shale gas inside the matrix block. The subscript D represents dimensionless. The subscript f represents the fracture network. ϕ represents porosity. The subscript m represents the matrix. The subscript F represents the hydraulically created fracture. The subscript 0 represents an initial state. Vim represents a concentration in different zones, i=1, 2, 3, 4, 5; V₁ₘ represents a shale gas concentration in zone I, including the concentration of adsorbed phase and free phase.

The initial concentration of shale gas inside the matrix block is expressed as:

$${V}_{i} = \frac{{ϕ}_{m} {Z}_{s c} {T}_{s c}}{Z T {p}_{s c}} {p}_{i} + ( 1 - {ϕ}_{m} ) \frac{{p}_{i} {V}_{L}}{{p}_{i} + {p}_{L}}$$

In the equation, pᵢ represents an original formation pressure.

Step 104: Solve the zone V diffusion equation by the dimensionless transform relationship and Laplace transform to obtain a solution of the zone V diffusion equation.

Step 104 may specifically include:

Dimensionless transform is performed on the zone V diffusion equation by the dimensionless transform relationship to obtain a zone V dimensionless diffusion equation.

Laplace transform is performed on the zone V dimensionless diffusion equation to obtain a zone V dimensionless diffusion equation in the Laplace space. The diffusion direction of zone V is the −x direction of the Cartesian coordinate system, then the zone V dimensionless diffusion equation is subjected to Laplace transform based on the dimensionless time t_{D} to obtain a zone V dimensionless diffusion equation in the Laplace space:

$$\frac{{\partial }^{2} \overline{{V}_{5 m D}}}{\partial {x}_{D}^{2}} = \frac{s}{{D}_{5 m D}} \overline{{V}_{5 m D}} \qquad ( 7 )$$

In the equation, V̅_̅{̅5̅m̅D̅}̅ represents a dimensionless matrix gas concentration of zone V in the Laplace space; x_{D} represents a dimensionless variable x; s is a Laplace variable, defined during the Laplace transform; D_{5mD} represents a dimensionless matrix diffusion coefficient of zone V; V_{5mD} represents a dimensionless matrix gas concentration in zone V.

A boundary condition of pure matrix zone V is obtained. The zone V boundary condition includes an outer boundary condition

$$\frac{\partial \overline{{V}_{5 m D}}}{\partial {x}_{D}} {\vert}_{{x}_{D} = {x}_{eD}} = 0$$

and an inner boundary condition V̅_̅{̅5̅m̅D̅}̅|ₓ_{_{D}}₌₁=V̅_̅{̅3̅m̅D̅}̅|ₓ_{_{D}}₌₁, where, V̅_̅{̅3̅m̅D̅}̅ represents a dimensionless matrix gas concentration in zone III in the Laplace space; x_{eD} represents a dimensionless boundary length in the x direction; V̅_̅{̅3̅m̅D̅}̅ represents a dimensionless matrix gas concentration in zone III.

The zone V boundary condition is used to solve the zone V dimensionless diffusion equation in the Laplace space to obtain a solution of the zone V diffusion equation. The solution of the zone V diffusion equation (the zone V matrix diffusion equation) is:

$$\overline{{V}_{5 m D}} = \overline{{V}_{3 m D}} {\vert}_{{x}_{D} = 1} \frac{cosh [ \sqrt{s / {D}_{5 m D}} ( {x}_{e D} - {x}_{D} ) ]}{cosh [ \sqrt{s / {D}_{5 m D}} ( {x}_{e D} - 1 ) ]} \qquad ( 8 )$$

Step 105: Solve the zone IV diffusion equation by the dimensionless transform relationship and Laplace transform to obtain a solution of the zone IV diffusion equation.

Step 105 may specifically include:

Dimensionless transform is performed on the zone IV diffusion equation by the dimensionless transform relationship to obtain a zone IV dimensionless diffusion equation.

Laplace transform is performed on the zone IV dimensionless diffusion equation to obtain a zone IV dimensionless diffusion equation in the Laplace space.

A boundary condition of pure matrix zone IV is obtained. The zone IV boundary condition includes an outer boundary condition

$$\frac{\partial \overline{{V}_{4 m D}}}{\partial {x}_{D}} {\vert}_{{x}_{D} = {x}_{eD}} = 0$$

and an inner boundary condition V̅_̅{̅4̅m̅D̅}̅|ₓ_{_{D}}₌₁=V̅_̅{̅2̅ƒ̅d̅}̅|ₓ_{_{D}}₌₁, where, V̅_̅{̅4̅m̅D̅}̅ represents a dimensionless matrix gas concentration in zone IV in the Laplace space; V̅_̅{̅2̅ƒ̅d̅}̅| represents a dimensionless fracture gas concentration in zone II in the Laplace space.

The zone IV boundary condition is used to solve the zone IV dimensionless diffusion equation in the Laplace space to obtain a solution of the zone IV diffusion equation. The solution of the zone IV diffusion equation (the zone IV matrix diffusion equation) is:

$$\overline{{V}_{4 m D}} = \overline{{V}_{2 f D}} {\vert}_{{x}_{D} = 1} \frac{cosh [ \sqrt{s / {D}_{4 m D}} ( {x}_{e D} - {x}_{D} ) ]}{cosh [ \sqrt{s / {D}_{4 m D}} ( {x}_{e D} - 1 ) ]} \qquad ( 9 )$$

In the equation, V̅_̅{̅4̅m̅D̅}̅ represents a dimensionless matrix gas concentration in zone IV in the Laplace space; D_{4mD} represents a dimensionless matrix gas diffusion coefficient of zone IV; V_{2ƒD} represents a dimensionless gas concentration in the fracture network in zone II.

Step 106: Solve the zone III diffusion equation by the dimensionless transform relationship, Laplace transform and the solution of the zone V diffusion equation to obtain a solution of the zone III diffusion equation. Since the diffusion direction from the zone III matrix to the zone II fracture network is perpendicular to the diffusion direction from the zone V matrix to the zone III matrix, the diffusion of the zone III matrix is two-dimensional diffusion.

Step 106 may specifically include:

Dimensionless transform is performed on the zone III diffusion equation by the dimensionless transform relationship to obtain a zone III dimensionless diffusion equation.

Laplace transform is performed on the zone III dimensionless diffusion equation to obtain a zone III dimensionless diffusion equation in the Laplace space. The zone III dimensionless diffusion equation in the Laplace space is:

$$\frac{{\partial }^{2} \overline{{V}_{3 m D}}}{\partial {y}_{D}^{2}} + \frac{{D}_{5 m D}}{{D}_{3 m D}} \frac{\partial \overline{{V}_{5 m D}}}{\partial {x}_{D}} {\vert}_{{x}_{D} = 1} = \frac{1}{{D}_{3 m D}} \frac{\partial \overline{{V}_{3 m D}}}{\partial {t}_{D}} \qquad ( 10 )$$

In the equation, y_{D} represents a dimensionless variable y; D_{3mD} represents a dimensionless matrix gas diffusion coefficient of zone III.

Derivative finding is performed on the solution of the zone V diffusion equation. The derivative finding on the solution of the zone V matrix diffusion equation, i.e. Eq. (8), is as follows:

V̅_̅{̅5̅m̅D̅}̅|ₓ_{_{D}}₌₁=V̅_̅{̅3̅m̅D̅}̅|ₓ_{_{D}}₌₁\sqrt{s/D_{5mD}} tanh[\sqrt{s/D_{5mD}}(x_{eD}−1)] (11)

To facilitate the solution below, a first function ƒ₃(s) is defined as:

$${f}_{3} ( s ) = \frac{{D}_{5 m D}}{{D}_{3 m D}} \sqrt{s / {D}_{5 m D}} tanh [ \sqrt{s / {D}_{5 m D}} ( {x}_{e D} - 1 ) ] + \frac{s}{{D}_{3 m D}} . \qquad ( 12 )$$

A boundary condition of pure matrix zone III is obtained. The zone III boundary condition includes an outer boundary condition V̅_̅{̅3̅m̅D̅}̅|_{y}_{_{D}}_{=y}_{_{1D}}=V̅_̅{̅2̅ƒ̅d̅}̅|_{y}_{_{D}}_{=y}_{_{1D}} and an inner boundary condition

$$\frac{\partial \overline{{V}_{3 m D}}}{\partial {y}_{D}} {\vert}_{{y}_{D} = {y}_{e D}} = 0 ,$$

where, y_{1D} represents a dimensionless width of zone II; y_{eD} represents a dimensionless boundary length in the y direction.

According to the solution of the zone V diffusion equation after derivative finding, the zone III boundary condition is used to solve the zone III dimensionless diffusion equation in the Laplace space to obtain a solution of the zone III diffusion equation. By substituting the solution of the zone V diffusion equation (Eq. (11)) after derivative finding and the first function ƒ₃(s) (Eq. (12)) into the zone III dimensionless diffusion equation (Eq. (10)) in the Laplace space, Eq. (10) is reduced to:

$$\frac{{\partial }^{2} \overline{{V}_{3 m D}}}{\partial {y}_{D}^{2}} = {f}_{3} ( s ) \overline{{V}_{3 m D}} \qquad ( 13 )$$

Solving Eq. (13) with the zone III boundary condition yields a solution of the zone III diffusion equation (the zone III matrix diffusion equation) as follows:

$$\overline{{V}_{3 m D}} = \overline{{V}_{2 f D}} {\vert}_{{y}_{D} = {y}_{1 D}} \frac{cosh [ \sqrt{{f}_{3} ( s )} ( {y}_{e D} - {y}_{D} ) ]}{cosh [ \sqrt{{f}_{3} ( s )} ( {y}_{e D} - {y}_{1 D} ) ]} \qquad ( 14 )$$

Step 107: Solve the zone II seepage differential equation by the dimensionless transform relationship, Laplace transform, the zone II diffusion equation, the solution of the zone IV diffusion equation and the solution of the zone III diffusion equation to obtain a solution of the zone II seepage differential equation.

Step 107 may specifically include:

Dimensionless transform is performed on the zone II diffusion equation by the dimensionless transform relationship to obtain a zone II dimensionless diffusion equation. Using the dimensionless transform relationships V_{ED}=V_{E}−Vᵢ, V_{mD}=Vₘ−Vᵢ and

$$λ = \frac{{x}_{F}^{2}}{{η}_{f}} σ {D}_{m}$$

to nondimensionalize the diffusion process from the matrix of zone II to the fracture (Eq. (2)) yields a zone II dimensionless diffusion equation:

$$\frac{\partial {V}_{m D}}{\partial {t}_{D}} = λ ( {∇}_{E D} - {∇}_{m D} ) ,$$

where V_{mD} represents a dimensionless total concentration of shale gas inside the matrix block.

Laplace transform is performed on the zone II dimensionless diffusion equation to obtain a zone II dimensionless diffusion equation in the Laplace space. A pseudo-steady-state diffusion equation is used to describe the diffusion process from the matrix block to the fracture, and Laplace transform is performed on the zone II dimensionless diffusion equation to obtain a zone II dimensionless diffusion equation in the Laplace space:

$$\overline{{V}_{m D}} = \frac{λ}{λ + s} \overline{{V}_{E D}} \qquad ( 15 )$$

In the equation, V̅_̅{̅m̅D̅}̅ represents a dimensionless matrix gas concentration in the Laplace space; V̅_̅{̅E̅D̅}̅ represents a dimensionless gas concentration in the lapalce space when the matrix and the fracture are in equilibrium.

Dimensionless transform is performed on a pressure function of fracture network zone II by the dimensionless transform relationship to obtain a dimensionless shale gas concentration when the gas supply from the matrix block to fracture network zone II reaches equilibrium. The shale gas concentration V_{E} when the gas supply from the matrix block to the fracture network reaches equilibrium is a function of the fracture network pressure p_{f}, which produces the following equation according to the definition of dimensionless variable:

$$\overline{{V}_{E D}} = ( \frac{{ϕ}_{m} {Z}_{s c} {q}_{s c}}{Z π kh} \frac{{μ}_{i} {Z}_{i}}{2 {p}_{i}} + ( 1 - {ϕ}_{m} ) \frac{{p}_{L} {V}_{L}}{( {p}_{f} + {p}_{L} ) ( {p}_{i} + {p}_{L} )} \frac{{p}_{sc} {q}_{sc} T}{π {khT}_{sc}} \frac{{μ}_{i} {Z}_{i}}{2 {p}_{i}} ) \overline{{ψ}_{fD}} \qquad ( 16 )$$

In the equation, k represents a fracture permeability; μᵢ represents a gas viscosity in the initial state; Zᵢ represents a gas deviation coefficient in the initial state; ψ̅_̅{̅f̅D̅}̅ represents a dimensionless pseudo-pressure of the fracture system in the Laplace space.

Substituting the dimensionless shale gas concentration into the zone II dimensionless diffusion equation in the Laplace space leads to a matrix gas concentration of fracture network zone II. For the convenience of calculation, an adsorption/desorption index θ1 and a free gas index θ2 are defined to characterize the influence of the adsorbed gas and free gas in the matrix system on the gas supply to the fracture network. The adsorption/desorption index θ1 and the free gas index θ2 are expressed as:

$$\begin{matrix}θ 1 = \frac{{ϕ}_{m} {Z}_{s c} {q}_{sc}}{Z π k h} \frac{{μ}_{i} {Z}_{i}}{2 {p}_{i}} & ( 17 ) \\ θ2 = ( 1 - {ϕ}_{m} ) \frac{{p}_{L} {V}_{L}}{( {p}_{f} + {p}_{L} ) ( {p}_{i} + {p}_{L} )} \frac{{p}_{s c} {q}_{s c} T}{π k h {T}_{s c}} \frac{{μ}_{i} {Z}_{i}}{2 {p}_{i}} & ( 18 )\end{matrix}$$

Reducing Eq. (15) by Eqs. (17), (18) and (16) yields the matrix gas concentration in fracture network zone II:

$$\overline{{V}_{m D}} = \frac{λ ( θ 1 + θ 2 )}{λ + s} \overline{{ψ}_{f D}} \qquad ( 19 )$$

A pseudo-steady-state diffusion seepage differential equation of fracture network zone II is obtained according to fracture network zone II's matrix gas concentration, gas flow mechanism and seepage differential equation. The diffusion of the matrix block in zone II is pseudo-steady-state diffusion, so the gas flow mechanism of fracture network zone II is:

$${q}_{2 m} = \frac{\partial {V}_{2 m}}{\partial t} ,$$

where q₂ₘ is the amount of gas diffused from the matrix (or the gas supply amount from the matrix to the fracture), and V₂ₘ is the gas concentration of the matrix in zone II, V₂ₘ=V̅_̅{̅m̅D̅}̅.

By substituting the zone II matrix gas concentration equation (19) and the gas flow mechanism q₂ₘ of fracture network zone II to the zone II seepage differential equation, the pseudo-steady-state diffusion seepage differential equation of fracture network zone II is obtained.

Dimensionless transform is performed on the pseudo-steady-state diffusion seepage differential equation by the dimensionless transform relationship to obtain a differential equation of fracture network zone II. The gas of the fracture network in zone II comes from the matrix in zone IV and the matrix block in the fracture network of zone II. The defined dimensionless variables, i.e. dimensionless diffusion coefficient

$${D}_{m D} = \frac{{D}_{m}}{{η}_{f}} ,$$

storage coefficient

$$ω = \frac{2 π h}{{Z}_{s c} {q}_{s c}} {D}_{m} ,$$

inter-porosity flow coefficient

$$λ = \frac{{x}_{F}^{2}}{{η}_{f}} σ {D}_{m}$$

and dimensionless concentration V_{ED}=V_{E}−Vᵢ are used to nondimensionalize the pseudo-steady-state diffusion seepage differential equation, reducing the pseudo-steady-state diffusion seepage differential equation to the differential equation of fracture network zone II.

Laplace transform is performed on the zone II differential equation to obtain a zone II differential equation after the Laplace transform:

$$\frac{{\partial }^{2} \overline{{ψ}_{2 fD}}}{\partial {y}_{D}^{2}} + {ω}_{2} \frac{\partial \overline{{V}_{4 m D}}}{\partial {x}_{D}} {\vert}_{{x}_{D} = 1} = s \overline{{ψ}_{2 fD}} + \frac{s {ω}_{2}}{{D}_{2 m D}} \overline{{V}_{2 m D}} \qquad ( 20 )$$

In the equation, ψ̅_̅{̅j̅f̅D̅}̅ represents a dimensionless pseudo-pressure of the zone II fracture in the Laplace space; ω₂ is the defined storage coefficient,

$${ω}_{2} = \frac{2 π h}{{Z}_{s c} {q}_{s c}} {D}_{2 m} ;$$

D₂ₘ represents a diffusion coefficient of zone II; D_{2mD} represents a dimensionless diffusion coefficient of zone II; V̅_̅{̅2̅m̅D̅}̅ represents a dimensionless gas concentration of the zone II matrix in the Laplace space; ψ_{2ƒD} represents a dimensionless pseudo-pressure in the zone II fracture.

Derivative finding is performed on the solution of the zone IV diffusion equation. Because the second term on the left side of Eq. (20) includes the expression of the zone IV matrix diffusion equation after derivative finding, the solution of Eq. (20) requires the derivative finding of the zone IV matrix diffusion equation. The derivative finding on the zone IV matrix diffusion equation is as follows:

$$\frac{\partial \overline{{V}_{4 mD}}}{\partial {x}_{D}} {\vert}_{{x}_{D} = 1} = - \overline{{V}_{2 fD}} {\vert}_{{x}_{D} = 1} \sqrt{s \text{/} {D}_{4 mD}} tanh [ \sqrt{s \text{/} {D}_{4 mD}} ( {x}_{eD} - 1 ) ] \qquad ( 21 )$$

Using the solution of the zone IV diffusion equation after derivative founding to reduce the Laplace-transformed zone II differential equation leads to a reduced zone II differential equation (that is, a reduced Laplace-transformed zone II differential equation). To facilitate the solution, a second function ƒ₂(s) is defined:

$${f}_{2} ( s ) = {ω}_{2} ( \frac{{ϕ}_{2 f} {Z}_{sc} {q}_{sc}}{Z π kh} \frac{{μ}_{i} {Z}_{i}}{2 {p}_{i}} ) \sqrt{s \text{/} {D}_{4 mD}} tanh [ \sqrt{s \text{/} {D}_{4 mD}} ( {x}_{eD} - 1 ) ] + s + \frac{s {ω}_{2}}{{D}_{2 mD}} \frac{{λ}_{2 m} ( {θ1}_{2 m} + {θ2}_{2 m} )}{{λ}_{2 m} + s} \qquad ( 22 )$$

In the equation, ϕ_{2ƒ} represents a porosity of the fracture network; λ₂ₘ represents an inter-porosity flow coefficient of the zone II matrix; θ1₂ₘ represents an adsorption/desorption index of the zone II matrix; θ2₂ₘ represents a free gas index of zone II.

Substituting the solution of the zone IV diffusion equation (Eq. (21)) after derivative finding and the second function ƒ₂(s) (Eq. (22)) into the Laplace-transformed zone II differential equation leads to a reduced zone II differential equation:

$$\frac{{\partial }^{2} \overline{{ψ}_{2 fD}}}{\partial {y}_{D}^{2}} - {f}_{2} ( s ) \overline{{φ}_{2 fD}} = 0 \qquad ( 23 )$$

In the equation, φ̅_̅{̅2̅ƒ̅D̅}̅ represents a dimensionless pseudo-pressure in the zone II fracture in the Laplace space.

The reduced zone II differential equation is solved to obtain a general solution of the reduced zone II differential equation. The general solution of the seepage differential equation of fracture network zone II is:

ψ̅_̅{̅2̅ƒ̅d̅}̅(y_{D})=A cosh[\sqrt{ƒ₂(s)}(y_{D}−y_{1D})]+B sinh [\sqrt{ƒ₂(s)}(y_{D}−y_{1D})] (24)

In the equation, A and B represent undetermined coefficients for the general solution of the seepage differential equation of fracture network zone II.

Derivative finding is performed on the solution of the zone III diffusion equation. The derivative finding on the solution of the zone III matrix diffusion equation is as follows:

$$\frac{\partial \overline{{V}_{3 mD}}}{\partial {y}_{D}} {\vert}_{{y}_{D} = {y}_{1 D}} = - \overline{{V}_{2 fD}} {\vert}_{{y}_{D} = {y}_{1 D}} \sqrt{{f}_{3} ( s )} tanh [ \sqrt{{f}_{3} ( s )} ( {y}_{eD} - {y}_{1 D} ) ] \qquad ( 25 )$$

A second preset condition is obtained, where the second preset condition is y_{D}=y_{1D}.

Derivative finding is performed on the general solution in the second preset condition. When y_{D}=y_{1D}, A and B are expressed by:

$$\overline{{ψ}_{2 fD}} {\vert}_{{y}_{D} = {y}_{1 D}} = A ; \frac{\partial \overline{{ψ}_{2 fD}}}{\partial {y}_{D}} {\vert}_{{y}_{D} = {y}_{1 D}} = B \sqrt{{f}_{2} ( s )} .$$

Substituting the expressions of A and B into Eq. (24) yields the general solution in the second preset condition:

$$\overline{{ψ}_{2 fD}} ( {y}_{D} ) = \overline{{ψ}_{2 fD}} {\vert}_{{y}_{D} = {y}_{1 D}} cosh [ \sqrt{{f}_{2} ( s )} ( {y}_{D} - {y}_{1 D} ) ] + \frac{\partial \overline{{ψ}_{2 fD}}}{\partial {y}_{D}} {\vert}_{{y}_{D} = {y}_{1 D}} sinh [ \sqrt{{f}_{2} ( s )} ( {y}_{D} - {y}_{1 D} ) ] \text{/} \sqrt{{f}_{2} ( s )}$$

Derivative finding is performed on Eq. (26).

According to the solution of the zone III diffusion equation after derivative finding and a relationship between the fracture gas concentration and pseudo-pressure, the general solution in the second preset condition after derivative finding is used to obtain an outer boundary condition of fracture network zone II. Considering the relationship between the fracture gas concentration and pseudo-pressure:

$$\overline{{V}_{2 fD}} {\vert}_{{y}_{D} = {y}_{1 D}} = ( \frac{{ϕ}_{2 f} {Z}_{sc} {q}_{sc}}{Z π kh} \frac{{μ}_{i} {Z}_{i}}{2 {p}_{i}} ) \overline{{ψ}_{2 fD}} {\vert}_{{y}_{D} = {y}_{1 D}} \qquad ( 27 )$$

the solutions of the zone III diffusion equation after derivative finding, namely Eq. (25) and Eq. (27), are substituted into the general solution in the second preset condition after derivative finding, to obtain the outer boundary condition of the zone II seepage differential equation:

$$\frac{\partial \overline{{ψ}_{2 fD}}}{\partial {y}_{D}} {\vert}_{{y}_{D} = {y}_{1 D}} = - \overline{{ψ}_{2 fD}} {\vert}_{{y}_{D} = {y}_{1 D}} {ω}_{3} ( \frac{{ϕ}_{2 f} {Z}_{sc} {q}_{sc}}{Z π kh} \frac{{μ}_{i} {Z}_{i}}{2 {p}_{i}} ) \sqrt{{f}_{3} ( s )} tanh [ \sqrt{{f}_{3} ( s )} ( {y}_{eD} - {y}_{1 D} ) ] \qquad ( 28 )$$

In the equation, ω₃ is the defined storage coefficient, and

$${ω}_{3} = \frac{2 π h}{{Z}_{sc} {q}_{sc}} {D}_{3 m} ,$$

D₃ₘ represents a diffusion coefficient of zone III.

To facilitate the solution, a third function z₃(s) is defined:

$${z}_{3} ( s ) = {ω}_{3} ( \frac{{ϕ}_{2 f} {Z}_{sc} {q}_{sc}}{Z π kh} \frac{{μ}_{i} {Z}_{i}}{2 {p}_{i}} ) tanh [ \sqrt{{f}_{3} ( s )} ( {y}_{eD} - {y}_{1 D} ) ] \sqrt{{f}_{3} ( s )} \text{/} \sqrt{{f}_{2} ( s )} \qquad ( 29 )$$

Reducing Eq. (28) by the third function z₃(s) yields the outer boundary condition of fracture network zone II:

$$\frac{\partial \overline{{ψ}_{2 fD}}}{\partial {y}_{D}} {\vert}_{{y}_{D} = {y}_{1 D}} = - {z}_{3} ( s ) \sqrt{{f}_{2} ( s )} \overline{{ψ}_{2 fD}} {\vert}_{{y}_{D} = {y}_{1 D}} . \qquad ( 30 )$$

An inner boundary condition of fracture network zone II is obtained. The pressure at the interface of zone II and zone I is equal, so the inner boundary condition of zone II is: ψ̅_̅{̅2̅ƒ̅D̅}̅|_{y}_{_{D}}_{=W}_{_{FD}}_{/2}=ψ̅_̅{̅1̅F̅D̅}̅|_{y}_{_{D}}_{=W}_{_{FD}}_{/2} (31). In the equation, ψ_{1FD} represents a dimensionless pseudo-pressure in the main fracture of zone I in the Laplace space.

The zone II outer boundary condition, the zone II inner boundary condition and the general solution in the second preset condition are used to obtain a solution of the zone II seepage differential equation. Substituting the zone II outer boundary condition (Eq. (30)) into the general solution (Eq. (26)) in the second preset condition leads to:

ψ̅_̅{̅2̅ƒ̅d̅}̅(y_{D})=ψ̅_̅{̅2̅ƒ̅D̅}̅|_{y}_{_{D}}_{=y}_{_{1D}} cosh[\sqrt{ƒ₂(s)}(y_{D}−y_{1D})]−z₃(s)ψ̅_̅{̅2̅ƒ̅D̅}̅|_{y}_{_{D}}_{=y}_{_{1D}} sinh[\sqrt{ƒ₂(s)}(y_{D}−y_{1D})] (34)

Eq. (32) produces:

ψ̅_̅{̅2̅ƒ̅d̅}̅(y_{D})=ψ̅_̅{̅2̅ƒ̅D̅}̅|_{y}_{_{D}}_{=y}_{_{1D}}{cosh[\sqrt{ƒ₂(s)}(y_{D}−y_{1D})]−z₃(s)sinh[\sqrt{ƒ₂(s)}(y_{D}−y_{1D})]} (33)

Substituting the zone II inner boundary condition (Eq. (31)) into Eq. (33) leads to:

$$\overline{{ψ}_{2 fD}} {\vert}_{{y}_{D} = {W}_{FD} \text{/} 2} = \overline{{ψ}_{1 FD}} {\vert}_{{y}_{D} = {W}_{FD} \text{/} 2} = \overline{{ψ}_{2 fD}} {\vert}_{{y}_{D} = {y}_{1 D}} \{ cosh [ \sqrt{{f}_{2} ( s )} ( {W}_{FD} \text{/} 2 - {y}_{1 D} ) ] - {z}_{3} ( s ) sinh [ \sqrt{{f}_{2} ( s )} ( {W}_{FD} \text{/} 2 - {y}_{1 D} ) ] \} \qquad ( 34 )$$

Eq. (34) produces:

ψ̅_̅{̅2̅ƒ̅d̅}̅|_{y}_{_{D}}_{=y}_{_{1D}}=ψ̅_̅{̅1̅F̅D̅}̅|_{y}_{_{D}}_{=W}_{_{FD}}_{/2}/{cosh[\sqrt{ƒ₂(s)}(W_{FD}/2−y_{1D})]−z₃(s)sinh[\sqrt{ƒ₂(s)}(W_{FD}/2−y_{1D})]} (35)

To facilitate the solution, a fourth function h₂(s) and a fifth function c₂(s, y_{D}) are defined:

$$\begin{matrix}{h}_{2} ( s ) = cosh [ \sqrt{{f}_{2} ( s )} ( {W}_{FD} \text{/} 2 - {y}_{1 D} ) ] - {z}_{3} ( s ) sinh [ \sqrt{{f}_{2} ( s )} ( {W}_{FD} \text{/} 2 - {y}_{1 D} ) ] & ( 36 ) \\ {c}_{2} ( s , {y}_{D} ) = \frac{cosh [ \sqrt{{f}_{2} ( s )} ( {y}_{D} - {y}_{1 D} ) ] - {z}_{3} ( s ) sinh [ \sqrt{{f}_{2} ( s )} ( {y}_{D} {-}_{1 D} ) ]}{{h}_{2} ( s )} & ( 37 )\end{matrix}$$

Reducing Eq. (35) by Eqs. (36) and (37) yields a solution of the zone II seepage differential equation:

ψ̅_̅{̅2̅ƒ̅d̅}̅(y_{D})=c₂(s,y_{D})ψ̅_̅{̅1̅F̅D̅}̅|_{y}_{_{D}}_{=W}_{_{FD}}_{/2} (38)

Step 108: Solve the zone I seepage differential equation by the dimensionless transform relationship, Laplace transform and the solution of the zone II seepage differential equation to obtain a solution of the zone I seepage differential equation.

Step 108 may specifically include:

Dimensionless transform is performed on the zone I seepage differential equation by the dimensionless transform relationship to obtain a zone I dimensionless seepage differential equation. According to the equation of state of an ideal gas and the definition of pseudo-pressure, Eq. (1) may be transformed into:

$$\frac{{\partial }^{2} {ψ}_{F}}{\partial {x}^{2}} + \frac{{\partial }^{2} {ψ}_{F}}{\partial {y}^{2}} = \frac{{ϕ}_{F} {c}_{F} μ}{{k}_{F}} \frac{\partial {ψ}_{F}}{\partial t} \qquad ( 39 )$$

In the equation, ψ_{F} represents a pseudo-pressure in the main fracture of zone I.

According to the dimensionless definition, Eq. (39) is reduced into a zone I dimensionless seepage differential equation:

$$\frac{{\partial }^{2} {ψ}_{FD}}{\partial {x}_{D}^{2}} + \frac{{\partial }^{2} {ψ}_{FD}}{\partial {y}_{D}^{2}} = \frac{1}{{η}_{FD}} \frac{\partial {ψ}_{FD}}{\partial {t}_{D}} \qquad ( 40 )$$

In the equation, ω_{FD} represents a dimensionless pseudo-pressure of the zone I fracture, and η_{FD} represents a dimensionless conductivity factor of the zone I fracture.

A calculus operation is performed on the zone I dimensionless seepage differential equation, and a zone I dimensionless seepage differential equation is obtained after the calculus operation. Along the seepage direction of the fracture network, integration is performed from the interface of the fracture network and the hydraulically created fracture to the half width of the hydraulically created fracture. By performing the calculus operation on the zone I dimensionless seepage differential equation (Eq. (40)), Eq. (40) is reduced into a zone I dimensionless seepage differential equation after the calculus operation:

$$\frac{{\partial }^{2} {ψ}_{FD}}{\partial {x}_{D}^{2}} + \frac{2}{{W}_{FD}} \frac{\partial {ψ}_{FD}}{\partial {y}_{D}} {\vert}_{{y}_{D} = \frac{{W}_{FD}}{2}} = \frac{1}{{η}_{FD}} \frac{\partial {ψ}_{FD}}{\partial {t}_{D}} \qquad ( 41 )$$

A continuous relationship of a gas flow flux at the interface between fracture network zone II and the hydraulically created fracture is obtained. It is considered that the gas flow flux at the interface between the fracture network and the hydraulic fracture is continuous, that is, there is a continuous relationship of the gas flow flux:

$${k}_{F} h \frac{\partial {ψ}_{F}}{\partial y} {\vert}_{y = {W}_{F} \text{/} 2} = {k}_{f} h \frac{\partial {ψ}_{f}}{\partial y} {\vert}_{y = {W}_{F} \text{/} 2} . \qquad ( 42 )$$

In the equation, ψ_{F} represents a pseudo-pressure of the hydraulically created fracture, and ψ_{f}, represents a pseudo-pressure of the zone II fracture.

According to the continuous relationship of the gas flow flux and the dimensionless transform relationship, dimensionless transform is performed on the zone I dimensionless seepage differential equation after calculus operation, to obtain a reduced zone I seepage differential equation. According to the continuous relationship of the gas flow flux (Eq. 42) and the dimensionless transform relationship, dimensionless transform is performed on the zone I dimensionless seepage differential equation (Eq. 41) after calculus operation, to obtain a reduced zone I seepage differential equation:

$$\frac{\partial {ψ}_{FD}}{\partial {x}_{D}^{2}} + \frac{2}{{F}_{CD}} \frac{\partial {ψ}_{FD}}{\partial {y}_{D}} {\vert}_{{y}_{D} = \frac{{W}_{FD}}{2}} = \frac{1}{{η}_{FD}} \frac{\partial {ψ}_{FD}}{\partial {t}_{D}} \qquad ( 43 )$$

Laplace transform is performed on the reduced zone I seepage differential equation, and a zone I seepage differential equation is obtained after the Laplace transform. Laplace transform is performed on the seepage differential equation (Eq. 43) of the hydraulically created fracture based on the dimensionless time t_{D}, and a zone I seepage differential equation is obtained after the Laplace transform:

$$\frac{{\partial }^{2} \overline{{ψ}_{FD}}}{\partial {x}_{D}^{2}} + \frac{2}{{F}_{CD}} \frac{\partial \overline{{ψ}_{FD}}}{\partial {y}_{D}} {\vert}_{{y}_{D} = \frac{{W}_{FD}}{2}} = \frac{s}{{η}_{FD}} \overline{{ψ}_{FD}} \qquad ( 44 )$$

In the equation, ψ̅_̅{̅F̅D̅}̅ represents a dimensionless pseudo-pressure of the hydraulically created fracture in the Laplace space.

Derivative finding is performed on the solution of the zone II seepage differential equation. The solution of the zone II seepage differential equation after derivative finding is:

$$\frac{\partial \overline{{ψ}_{2 fD}}}{\partial {y}_{D}} {\vert}_{{y}_{D} = {W}_{FD} \text{/} 2} = \overline{{ψ}_{1 FD}} {\vert}_{{y}_{D} = {W}_{FD} \text{/} 2} \frac{\begin{matrix}\sqrt{{f}_{2} ( s )} sinh [ \sqrt{{f}_{2} ( s )} ( {W}_{FD} \text{/} 2 - {y}_{1 D} ) ] - \\ {z}_{3} ( s ) \sqrt{{f}_{2} ( s )} cosh [ \sqrt{{f}_{2} ( s )} ( {W}_{FD} \text{/} 2 - {y}_{1 D} ) ]\end{matrix}}{{h}_{2} ( s )} \qquad ( 45 )$$

To facilitate the solution, a six function F₂(s) is defined:

$${F}_{2} ( s ) = \frac{\begin{matrix}\sqrt{{f}_{2} ( s )} sinh [ \sqrt{{f}_{2} ( s )} ( {W}_{FD} \text{/} 2 - {y}_{1 D} ) ] - \\ {z}_{3} ( s ) \sqrt{{f}_{2} ( s )} cosh [ \sqrt{{f}_{2} ( s )} ( {W}_{FD} \text{/} 2 - {y}_{1 D} ) ]\end{matrix}}{{h}_{2} ( s )} \qquad ( 46 )$$

Reducing Eq. (45) by the sixth function F₂(s) (Eq. (46)) leads to:

$$\frac{\partial \overline{{ψ}_{2 fD}}}{\partial {y}_{D}} {\vert}_{{y}_{D} = {W}_{FD} \text{/} 2} = \overline{{ψ}_{1 FD}} {\vert}_{{y}_{D} = {W}_{FD} \text{/} 2} {F}_{2} ( s ) \qquad ( 47 )$$

A boundary condition of hydraulically fractured zone I is obtained. The zone I boundary condition is defined by the characteristics of hydraulically fractured zone I. The outer boundary of zone I is a distal end of the fracture, which is assumed to be a no-flow boundary; the inner boundary of zone I is the interface between the hydraulically created fracture and the wellbore.

The zone I boundary condition includes an outer boundary condition:

$$\frac{\partial \overline{{ψ}_{1 FD}}}{\partial {x}_{D}} {\vert}_{{x}_{D} = 1} = 0 ,$$

and an inner boundary condition:

$$\frac{\partial \overline{{ψ}_{1 FD}}}{\partial {x}_{D}} {\vert}_{{x}_{D} = 0} = \frac{π}{{sF}_{CD}} ,$$

where F_{CD} represents a dimensionless conductivity.

According to the solution of the zone II seepage differential equation after derivative finding, the zone I boundary condition is used to solve the zone I seepage differential equation after Laplace transform, to obtain a solution of the zone I seepage differential equation. The solution (Eq. (47)) of the zone II seepage differential equation after derivative finding is substituted into the zone I seepage differential equation (Eq. (44)) after Laplace transform. In order to facilitate the solution, a seventh function g₂(s) is defined:

$${g}_{2} ( s ) = \frac{s}{{η}_{1 FD}} - \frac{2}{{F}_{CD}} {F}_{2} ( s ) \qquad ( 48 )$$

In the equation, η_{1FD} represents a dimensionless conductivity factor of the hydraulically created fracture.

Substituting Eq. (47) into Eq. (44) and reducing Eq. (44) by the defined seventh function g₂(s) lead to:

$$\frac{{\partial }^{2} \overline{{ψ}_{1 FD}}}{\partial {x}_{D}^{2}} = {g}_{2} ( s ) \overline{{ψ}_{1 FD}} \qquad ( 49 )$$

Solving Eq. (49) with the zone I boundary condition yields a solution of the zone I seepage differential equation:

$$\overline{{ψ}_{1 FD}} = \frac{π}{{sF}_{CD} \sqrt{{g}_{2} ( s )}} \frac{cosh [ \sqrt{{g}_{2} ( s )} ( 1 - {x}_{D} ) ]}{sinh ( \sqrt{{g}_{2} ( s )} )} \qquad ( 50 )$$

Step 109: Obtain a first preset condition, where the first preset condition is x_{D}=0.

Step 110: Use the solution of the zone I seepage differential equation to obtain a bottom hole pseudo-pressure solution according to the first preset condition.

Step 110 may specifically include:

Substituting the first preset condition into the solution of the zone I seepage differential equation leads to a bottom hole pseudo-pressure solution. The first preset condition x_{D}=0 is substituted into the solution (Eq. (50)) of the zone I seepage differential equation to obtain a bottom hole pseudo-pressure solution. When x_{D}=0, the bottom hole pseudo-pressure solution is:

$$\overline{{ψ}_{wD}} = \overline{{ψ}_{1 FD}} {\vert}_{{x}_{D} = 0} = \frac{2 π}{{sF}_{CD} \sqrt{{g}_{2} ( s )} tanh \sqrt{{g}_{2} ( s )}} \qquad ( 51 )$$

In the equation, ψ̅_̅{̅w̅D̅}̅ represents a dimensionless bottom hole pseudo-pressure in the Laplace space.

Step 111: Obtain a dimensionless production solution by Duhamel's Principle according to the bottom hole pseudo-pressure solution. According to Duhamel's Principle, the bottom hole pseudo-pressure which considers the skin effect and reservoir effect in the Laplace space is:

$$\overline{{p}_{wD}} = \frac{s \overline{{ψ}_{wD}} + {S}_{c}}{s + {C}_{D} {s}^{2} ( s \overline{{ψ}_{wD}} + {S}_{c} )} \qquad ( 52 )$$

In the equation, p̅_̅{̅w̅D̅}̅ represents a dimensionless bottom hole pseudo-pressure considering the skin effect and the storage effect in the Laplace space; S_{c} is a skin coefficient, and C_{D} is a dimensionless storage coefficient.

According to the research results Error! Reference source not found. of Van Everdingen and Hurst, in the Laplace space, a dimensionless bottom hole pseudo-pressure under constant production conditions and a dimensionless production under constant pressure conditions have the following conversion relationship:

$${\overline{q}}_{wD} = \frac{1}{{s}^{2} \overline{{p}_{wD}}} \qquad ( 53 )$$

In the equation, q̅_{wD} represents a dimensionless production considering the skin effect and the storage effect in the Laplace space under constant pressure conditions.

Substituting Eq. (51) into Eq. (52) yields the dimensionless bottom hole pseudo-pressure considering the skin effect and the storage effect under constant production conditions, and substituting the conversion relationship (Eq. (53)) and the dimensionless bottom hole pseudo-pressure (Eq. (52)) yields the dimensionless production solution in the Laplace space.

Step 112: Predict the production of the fractured horizontal well in the shale gas reservoir by using a Stehfest numerical inversion method according to the dimensionless production solution.

Step 112 may specifically include: The Stehfest numerical inversion method is used to numerically solve the dimensionless production solution to obtain the predicted production of the fractured horizontal well in the shale gas reservoir.

This embodiment further provides a system for predicting the production of a fractured horizontal well in a shale gas reservoir. The system for predicting the production of a fractured horizontal well in a shale gas reservoir includes: a seepage zone dividing module, a seepage zone equation obtaining module, a dimensionless transform relationship obtaining module, a zone V diffusion equation solving module, a zone IV diffusion equation solving module, a zone III diffusion equation solving module, a zone II seepage differential equation solving module, a zone I seepage differential equation solving module, a first preset condition obtaining module, a bottom hole pseudo-pressure solution obtaining module, a dimensionless production solution obtaining module and a production predicting module.

The seepage zone dividing module is configured to divide a fractured horizontal well to be predicted in a shale gas reservoir into five seepage zones according to a matrix block and a fracture network after hydraulic fracturing, where the five seepage zones include: hydraulically fractured zone I, fracture network zone II, pure matrix zone III, pure matrix zone IV and pure matrix zone V.

The seepage zone equation obtaining module is configured to obtain a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V.

The dimensionless transform relationship obtaining module is configured to obtain a preset dimensionless transform relationship.

The zone V diffusion equation solving module is configured to solve the zone V diffusion equation by the dimensionless transform relationship and Laplace transform to obtain a solution of the zone V diffusion equation.

The zone V diffusion equation solving module may specifically include a zone V dimensionless transform unit, a zone V Laplace transform unit, a zone V boundary condition obtaining unit and a zone V dimensionless diffusion equation solving unit. The zone V dimensionless transform unit is configured to perform dimensionless transform on the zone V diffusion equation by the dimensionless transform relationship to obtain a zone V dimensionless diffusion equation.

The zone V Laplace transform unit is configured to perform Laplace transform on the zone V dimensionless diffusion equation to obtain a zone V dimensionless diffusion equation in a Laplace space.

The zone V boundary condition obtaining unit is configured to obtain a boundary condition of pure matrix zone V.

The zone V dimensionless diffusion equation solving unit is configured to use the zone V boundary condition to solve the zone V dimensionless diffusion equation in the Laplace space to obtain a solution of the zone V diffusion equation.

The zone IV diffusion equation solving module is configured to solve the zone IV diffusion equation by the dimensionless transform relationship and Laplace transform to obtain a solution of the zone IV diffusion equation.

The zone IV diffusion equation solving module may specifically include a zone IV dimensionless transform unit, a zone IV Laplace transform unit, a zone IV boundary condition obtaining unit and a zone IV dimensionless diffusion equation solving unit. The zone IV dimensionless transform unit is configured to perform dimensionless transform on the zone IV diffusion equation by the dimensionless transform relationship to obtain a zone IV dimensionless diffusion equation.

The zone IV Laplace transform unit is configured to perform Laplace transform on the zone IV dimensionless diffusion equation to obtain a zone IV dimensionless diffusion equation in the Laplace space.

The zone IV boundary condition obtaining unit is configured to obtain a boundary condition of pure matrix zone IV.

The zone IV dimensionless diffusion equation solving unit is configured to use the zone IV boundary condition to solve the zone IV dimensionless diffusion equation in the Laplace space to obtain a solution of the zone IV diffusion equation.

The zone III diffusion equation solving module is configured to solve the zone III diffusion equation by the dimensionless transform relationship, Laplace transform and the solution of the zone V diffusion equation to obtain a solution of the zone III diffusion equation.

The zone III diffusion equation solving module may specifically include a zone III dimensionless transform unit, a zone III Laplace transform unit, a zone V diffusion equation solution derivative finding unit, a zone III boundary condition obtaining unit and a zone III dimensionless diffusion equation solving unit. The zone III dimensionless transform unit is configured to perform dimensionless transform on the zone III diffusion equation by the dimensionless transform relationship to obtain a zone III dimensionless diffusion equation.

The zone III Laplace transform unit is configured to perform Laplace transform on the zone III dimensionless diffusion equation to obtain a zone III dimensionless diffusion equation in the Laplace space.

The zone V diffusion equation solution derivative finding unit is configured to perform derivative finding on the solution of the zone V diffusion equation.

The zone III boundary condition obtaining unit is configured to obtain a boundary condition of pure matrix zone III.

The zone III dimensionless diffusion equation solving unit is configured to use the zone III boundary condition to solve the zone III dimensionless diffusion equation in the Laplace space according to the solution of the zone V diffusion equation after derivative finding, to obtain a solution of the zone III diffusion equation.

The zone II seepage differential equation solving module is configured to solve the zone II seepage differential equation by the dimensionless transform relationship, Laplace transform, the zone II diffusion equation, the solution of the zone IV diffusion equation and the solution of the zone III diffusion equation, to obtain a solution of the zone II seepage differential equation.

The zone II diffusion equation solving module may specifically include a zone II dimensionless transform unit, a zone II first Laplace transform unit, a dimensionless shale gas concentration solving unit, a zone II matrix gas concentration solving unit, a pseudo-steady-state diffusion seepage differential equation obtaining unit, a zone II differential equation obtaining unit, a zone II second Laplace transform unit, a zone IV diffusion equation solution derivative finding unit, a zone II differential equation reducing unit, a zone II differential equation general solution obtaining unit, a zone III diffusion equation solution derivative finding unit, a second preset condition obtaining unit, a second preset condition general solution derivative finding unit, a zone II outer boundary condition obtaining unit, a zone II inner boundary condition obtaining unit and a zone II seepage differential equation solving unit. The zone II dimensionless transform unit is configured to perform dimensionless transform on the zone II diffusion equation by the dimensionless transform relationship to obtain a zone II dimensionless diffusion equation.

The zone II first Laplace transform unit is configured to perform Laplace transform on the zone II dimensionless diffusion equation to obtain a zone II dimensionless diffusion equation in the Laplace space.

The dimensionless shale gas concentration solving unit is configured to perform dimensionless transform on a pressure function of fracture network zone II by the dimensionless transform relationship to obtain a dimensionless shale gas concentration when the gas supply from the matrix block to fracture network zone II reaches equilibrium.

The zone II matrix gas concentration solving unit is configured to substitute the dimensionless shale gas concentration into the zone II dimensionless diffusion equation in the Laplace space to obtain a matrix gas concentration of fracture network zone II.

The pseudo-steady-state diffusion seepage differential equation obtaining unit is configured to obtain a pseudo-steady-state diffusion seepage differential equation of fracture network zone II according to fracture network zone II's matrix gas concentration, gas flow mechanism and seepage differential equation.

The zone II differential equation obtaining unit is configured to perform dimensionless transform on the pseudo-steady-state diffusion seepage differential equation by the dimensionless transform relationship to obtain a differential equation of fracture network zone II.

The zone II second Laplace transform unit is configured to perform Laplace transform on the zone II differential equation to obtain a zone II differential equation after the Laplace transform.

The zone IV diffusion equation solution derivative finding unit is configured to perform derivative finding on the solution of the zone IV diffusion equation.

The zone II differential equation reducing unit is configured to use the solution of the zone IV diffusion equation after derivative founding to reduce the Laplace-transformed zone II differential equation to obtain a reduced zone II differential equation.

The zone II differential equation general solution obtaining unit is configured to solve the reduced zone II differential equation to obtain a general solution of the reduced zone II differential equation.

The zone III diffusion equation solution derivative finding unit is configured to perform derivative finding on the solution of the zone III diffusion equation.

The second preset condition obtaining unit is configured to obtain a second preset condition.

The second preset condition general solution derivative finding unit is configured to perform derivative finding on a general solution in the second preset condition.

The zone II outer boundary condition obtaining unit is configured to use the general solution in the second preset condition after the derivative finding to obtain an outer boundary condition of fracture network zone II, according to the solution of the zone III diffusion equation after derivative finding and a relationship between a fracture gas concentration and a pseudo-pressure.

The zone II inner boundary condition obtaining unit is configured to obtain an inner boundary condition of fracture network zone II.

The zone II seepage differential equation solving unit is configured to use the zone II outer boundary condition, the zone II inner boundary condition and the general solution in the second preset condition to obtain a solution of the zone II seepage differential equation.

The zone I seepage differential equation solving module is configured to solve the zone I seepage differential equation by the dimensionless transform relationship, Laplace transform and the solution of the zone II seepage differential equation to obtain a solution of the zone I seepage differential equation.

The zone I diffusion equation solving module may specifically include a zone I dimensionless transform unit, a calculus operation performing unit, a gas flow flux continuous relationship obtaining unit, a zone I dimensionless seepage differential equation reducing unit, a zone I Laplace transform unit, a zone II seepage differential equation solution derivative finding unit, a zone I boundary condition obtaining unit and a zone I seepage differential equation solving unit. The zone I dimensionless transform unit is configured to perform dimensionless transform on the zone I seepage differential equation by the dimensionless transform relationship to obtain a zone I dimensionless seepage differential equation.

The calculus operation performing unit is configured to perform a calculus operation on the zone I dimensionless seepage differential equation to obtain a zone I dimensionless seepage differential equation after the calculus operation.

The gas flow flux continuous relationship obtaining unit is configured to obtain a continuous relationship of a gas flow flux at an interface between fracture network zone II and the hydraulically created fracture.

The zone I dimensionless seepage differential equation reducing unit is configured to perform dimensionless transform on the zone I dimensionless seepage differential equation after calculus operation according to the continuous relationship of the gas flow flux and the dimensionless transform relationship, to obtain a reduced zone I seepage differential equation.

The zone I Laplace transform unit is configured to perform Laplace transform on the reduced zone I seepage differential equation to obtain a zone I seepage differential equation after the Laplace transform.

The zone II seepage differential equation solution derivative finding unit is configured to perform derivative finding on the solution of the zone II seepage differential equation.

The zone I boundary condition obtaining unit is configured to obtain a boundary condition of hydraulically fractured zone I.

The zone I seepage differential equation solving unit is configured to use the zone I boundary condition to solve the zone I seepage differential equation after the Laplace transform according to the solution of the zone II seepage differential equation after derivative finding, to obtain a solution of the zone I seepage differential equation.

The first preset condition obtaining module is configured to obtain a first preset condition.

The bottom hole pseudo-pressure solution obtaining module is configured to use the solution of the zone I seepage differential equation to obtain a bottom hole pseudo-pressure solution according to the first preset condition.

The bottom hole pseudo-pressure solution obtaining module may specifically include a bottom hole pseudo-pressure solution obtaining unit, configured to substitute the first preset condition into the solution of the zone I seepage differential equation to obtain a bottom hole pseudo-pressure solution.

The dimensionless production solution obtaining module is configured to obtain a dimensionless production solution by Duhamel's Principle according to the bottom hole pseudo-pressure solution.

The production predicting module is configured to predict the production of the fractured horizontal well in the shale gas reservoir by using a Stehfest numerical inversion method according to the dimensionless production solution.

The production predicting module may specifically include a production predicting unit, configured to use the Stehfest numerical inversion method to numerically solve the dimensionless production solution to obtain the predicted production of the fractured horizontal well in the shale gas reservoir.

The method and system for predicting the production of a fractured horizontal well in a shale gas reservoir in the present disclosure are used to carry out sensitivity analysis of production decline. The present disclosure takes the physical parameters and engineering parameters of the gas reservoir as input, sets the time required for prediction, obtains the predicted production, and plots the predicted production and the corresponding dimensionless time on the coordinates to obtain a typical curve of production decline in real space. The physical parameters and engineering parameters of the gas reservoir include reservoir parameters, gas reservoir temperature, original formation pressure, gas density, gas viscosity and gas compressibility. The reservoir parameters are shown in Table 1. By changing the parametric values, the sensitivity of factors affecting production decline is analyzed.

TABLE 1
Reservoir parameters

| Reservoir parameter | Value | Reservoir parameter | Value |
|---|---|---|---|
| Zone II size xₑ × yₑ × h (m) | 50 × 30 × 70 | Zone II matrix diffusion | 5 × 10⁻⁵ |
| | | coefficient D₂ₘ (m²/s) | |
| Model size xₑ × yₑ × h (m) | 100 × 100 × 70 | Zone III matrix diffusion | 5 × 10⁻⁶ |
| | | coefficient D₄ₘ (m²/s) | |
| Width of hydraulically | 0.005 | Zone IV matrix diffusion | 5 × 10⁻⁶ |
| created fracture W_{F} (m) | | coefficient D₄ₘ (m²/s) | |
| Half length of hydraulically | 50 | Zone V matrix diffusion | 5 × 10⁻⁶ |
| created fracture (m) | | coefficient D₅ₘ (m²/s) | |
| Matrix porosity (%) | 3 | Permeability of hydraulically | 500 |
| | | created fracture (mD) | |
| SRV zone fracture network | 0.1 | Isotherm adsorption volume | 3 |
| permeability (mD) | | V_{L} (sm³/m³t) | |
| SRV zone matrix diffusion | 5 × 10⁻⁵ | Isothermal adsorption | 4 |
| coefficient D₂ₘ (m²/s) | | pressure p_{L} (MPa) | |
| Dimensionless wellbore | 0.001 | Skin coefficient S_{c} | 0.1 |
| storage coefficient S_{c} | | | |

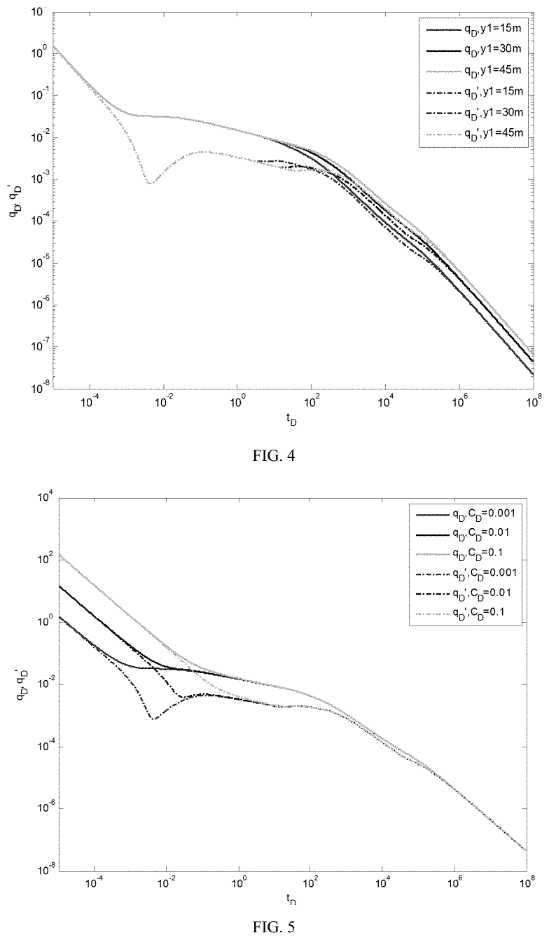

The parameters in Table 1 are substituted into the method and system for predicting the production of the fractured horizontal well in the shale gas reservoir. Only by changing the value of the width of the SRV zone, the dimensionless production solution corresponding to the width of the SRV zone is obtained. They are provided in FIGS. 4-9. The legends of FIGS. 4-9 show q_{D} and the derivative of q_{D} at different y1. As shown in FIG. 4, the width of the SRV zone does not affect the overall shape of the production decline curve, and it mainly affects the bilinear flow of the fracture and the matrix as well as the linear flow of the matrix. A larger value of the width of the SRV zone leads to farther propagation of the fracture, a longer duration of the bilinear flow of the fracture and the matrix, and a longer time for the gas well to maintain high production. The vertical axis in FIG. 4 shows the dimensionless production and the derivative thereof, where q_{D} represents the dimensionless production, and q_{D} represents the derivative of the dimensionless production (that is, the rate of change of production); y1 represents the width of the SRV zone.

As shown in FIG. 5, the wellbore storage coefficient mainly affects the initial stage of production. It is not easy to observe in actual production due to the short duration. The wellbore storage effect hardly affects the production stage following the linear flow of the fracture. In FIG. 5, C_{D} represents the dimensionless storage coefficient, and the horizontal axis represents the dimensionless time t_{D}.

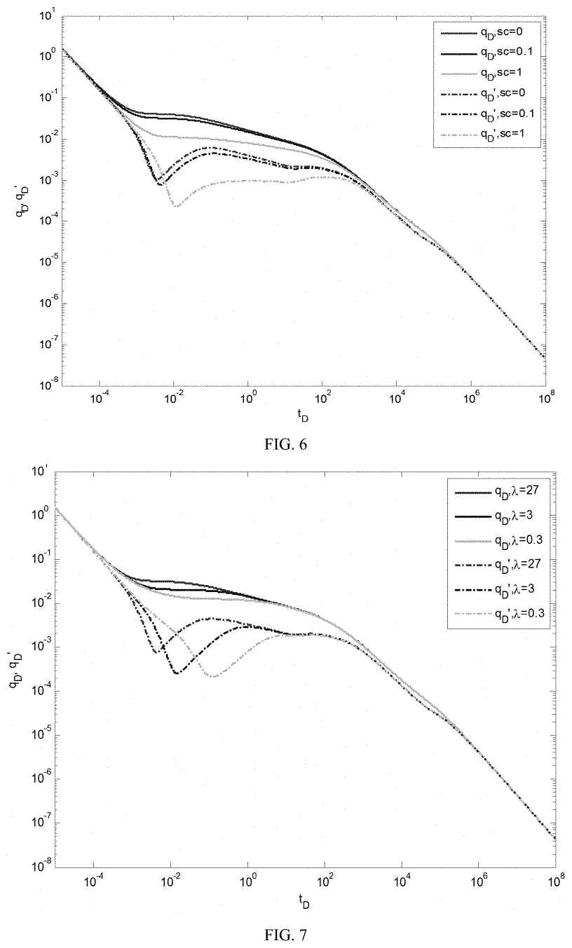

The skin coefficient S_{c} represents the degree of pollution near the wellbore. A larger skin coefficient indicates more serious pollution and a larger flow resistance, which means a lower production of the gas well under the same pressure difference. As shown in FIG. 6, the skin coefficient does not affect the gas flow during the storage effect stage of the wellbore. A larger skin coefficient leads to a greater depression of the dimensionless production derivative curve. The skin coefficient has a more obvious effect on the linear flow of the fracture in the early stage. After the bilinear flow of the fracture and the matrix is formed, this effect gradually decreases until it almost disappears.

The inter-porosity flow coefficient reflects the difference in the physical properties of the matrix and the fracture. As shown in FIG. 7, a larger inter-porosity flow coefficient λ indicates a greater difference, which makes it easier for the fluid in the matrix system to flow to the fracture network, and leads to an earlier start of the bilinear flow, a longer duration and a higher production.

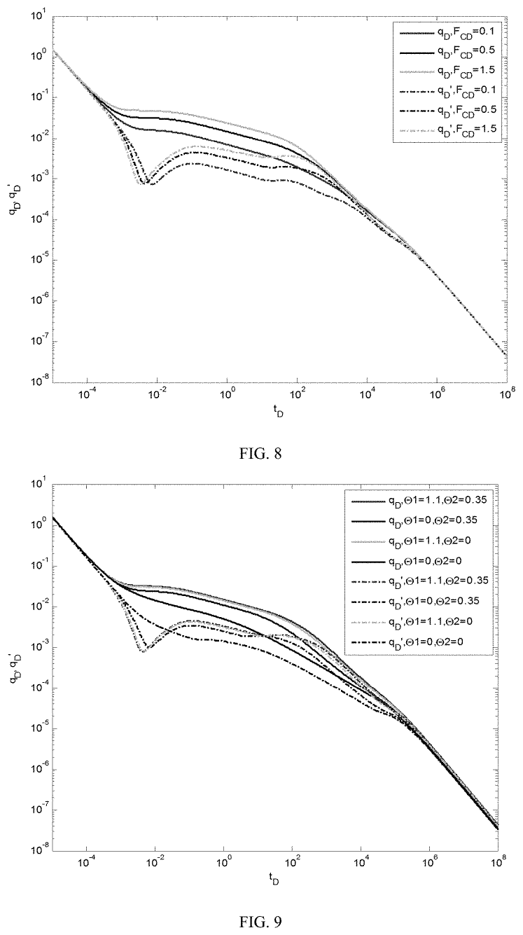

The fracture conductivity reflects the seepage capacity of the hydraulically created fracture. As shown in FIG. 8, a greater fracture permeability leads to a lower flow resistance for the fluid in the fracture, and indicates a stronger fracture conductivity, an earlier start of the linear flow of the fracture, and a higher production of the gas well. The fracture conductivity hardly affects the duration of each production decline stage. In FIG. 8, F_{CD} represents the fracture conductivity factor.

For the dual-medium SRV zone, the contribution of adsorbed gas and free gas in the matrix system to the fracture network is considered, and the adsorption/desorption index θ1 and free gas index θ2 are introduced to characterize the influence of the adsorbed gas and free gas in the matrix system on the gas supply to the fracture network. As shown in FIG. 9, when the gas supply of the matrix system to the fracture network is ignored, that is, when the adsorption/desorption index θ1 and the free gas index θ2 are both zero, the duration of the bilinear flow stage of the hydraulically created fracture and the fracture network in the treatment zone is very short. The Langmuir model is a pressure-based desorption model. When the pressure decreases, the adsorbed gas desorbs rapidly, so the contribution of the adsorbed gas to the fracture network in the matrix system is greater than that of the free gas.

The sensitivity analysis of production decline shows that: a greater width of the SRV zone leads to a longer time for the gas well to maintain a high production; a greater storage coefficient of the wellbore leads to a higher production in the initial stage; the skin coefficient has a more obvious effect on the linear flow in the early fracture; a larger inter-porosity flow coefficient indicates an earlier start of the bilinear flow, a longer duration and a higher production; a stronger fracture conductivity indicates an earlier start of the linear flow of the fracture and a higher production of the gas well; the contribution of the adsorbed gas to the fracture network in the matrix system is greater than that of free gas.

The present disclosure divides the fractured horizontal well in the shale gas reservoir into a fracture network zone (SRV zone) with a fracture-pore medium and pure matrix zones with a single porous medium. Considering the different diffusion modes of the matrix in different zones, the present disclosure uses Fick's First Law to describe the pseudo-steady-state diffusion of the matrix in the fracture network zone, Fick's Second Law to describe the unsteady-state diffusion of the matrix in the pure matrix zone, and Darcy's Law to describe the seepage in the fracture network. The present disclosure establishes a model for predicting the production of the fractured horizontal well in the shale gas reservoir under the conditions of matrix-microfracture coupling and hydraulically created fracture-microfracture coupling (as shown in steps 102 to 112). The present disclosure more accurately describes the actual flow law of the shale gas reservoir, provides a new method for production decline analysis and prediction of the shale gas well, and provides theoretical basis and production suggestions for the beneficial development of the shale gas reservoir. The matrix-microfracture coupling is reflected in the gas concentration difference between the matrix and the fracture, and the matrix supplies gas to the fracture by diffusion.

Each embodiment of the present specification is described in a progressive manner, each embodiment focuses on the difference from other embodiments, and the same and similar parts between the embodiments may refer to each other. For a system disclosed in the embodiments, since the system corresponds to the method disclosed in the embodiments, the description is relatively simple, and reference can be made to the method description.

In this specification, several specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and scope of application in accordance with the ideas of the present disclosure. In conclusion, the content of this specification should not be construed as a limitation to the present disclosure.

What is claimed is:

1. A method for predicting the production of a fractured horizontal well in a shale gas reservoir, comprising:
dividing a fractured horizontal well to be predicted in a shale gas reservoir into five seepage zones according to a matrix block and a fracture network after hydraulic fracturing, wherein the five seepage zones comprise: hydraulically fractured zone I, fracture network zone II, pure matrix zone III, pure matrix zone IV and pure matrix zone V;
obtaining a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V;
obtaining a preset dimensionless transform relationship;
solving the zone V diffusion equation by the dimensionless transform relationship and Laplace transform to obtain a solution of the zone V diffusion equation;
solving the zone IV diffusion equation by the dimensionless transform relationship and Laplace transform to obtain a solution of the zone IV diffusion equation;
solving the zone III diffusion equation by the dimensionless transform relationship, Laplace transform and the solution of the zone V diffusion equation to obtain a solution of the zone III diffusion equation;
solving the zone II seepage differential equation by the dimensionless transform relationship, Laplace transform, the zone II diffusion equation, the solution of the zone IV diffusion equation and the solution of the zone III diffusion equation to obtain a solution of the zone II seepage differential equation;
solving the zone I seepage differential equation by the dimensionless transform relationship, Laplace transform and the solution of the zone II seepage differential equation to obtain a solution of the zone I seepage differential equation;
obtaining a first preset condition;
using the solution of the zone I seepage differential equation to obtain a bottom hole pseudo-pressure solution according to the first preset condition;
obtaining a dimensionless production solution by Duhamel's Principle according to the bottom hole pseudo-pressure solution; and
predicting the production of the fractured horizontal well in the shale gas reservoir by using a Stehfest numerical inversion method according to the dimensionless production solution.

2. The method for predicting the production of a fractured horizontal well in a shale gas reservoir according to claim 1, wherein the solving the zone V diffusion equation by the dimensionless transform relationship and Laplace transform to obtain a solution of the zone V diffusion equation specifically comprises:
performing dimensionless transform on the zone V diffusion equation by the dimensionless transform relationship to obtain a zone V dimensionless diffusion equation;
performing Laplace transform on the zone V dimensionless diffusion equation to obtain a zone V dimensionless diffusion equation in a Laplace space;
obtaining a boundary condition of pure matrix zone V; and
using the zone V boundary condition to solve the zone V dimensionless diffusion equation in the Laplace space to obtain a solution of the zone V diffusion equation.

3. The method for predicting the production of a fractured horizontal well in a shale gas reservoir according to claim 1, wherein the solving the zone IV diffusion equation by the dimensionless transform relationship and Laplace transform to obtain a solution of the zone IV diffusion equation specifically comprises:
performing dimensionless transform on the zone IV diffusion equation by the dimensionless transform relationship to obtain a zone IV dimensionless diffusion equation;
performing Laplace transform on the zone IV dimensionless diffusion equation to obtain a zone IV dimensionless diffusion equation in the Laplace space;
obtaining a boundary condition of pure matrix zone IV; and
using the zone IV boundary condition to solve the zone IV dimensionless diffusion equation in the Laplace space to obtain a solution of the zone IV diffusion equation.

4. The method for predicting the production of a fractured horizontal well in a shale gas reservoir according to claim 1, wherein the solving the zone III diffusion equation by the dimensionless transform relationship, Laplace transform and the solution of the zone V diffusion equation to obtain a solution of the zone III diffusion equation specifically comprises:
performing dimensionless transform on the zone III diffusion equation by the dimensionless transform relationship to obtain a zone III dimensionless diffusion equation;
performing Laplace transform on the zone III dimensionless diffusion equation to obtain a zone III dimensionless diffusion equation in the Laplace space;
performing derivative finding on the solution of the zone V diffusion equation;
obtaining a boundary condition of pure matrix zone III; and
using the zone III boundary condition to solve the zone III dimensionless diffusion equation in the Laplace space according to the solution of the zone V diffusion equation after derivative finding, to obtain a solution of the zone III diffusion equation.

5. The method for predicting the production of a fractured horizontal well in a shale gas reservoir according to claim 1, wherein the solving the zone II seepage differential equation by the dimensionless transform relationship, Laplace transform, the zone II diffusion equation, the solution of the zone IV diffusion equation and the solution of the zone III diffusion equation to obtain a solution of the zone II seepage differential equation specifically comprises:
performing dimensionless transform on the zone II diffusion equation by the dimensionless transform relationship to obtain a zone II dimensionless diffusion equation;
performing Laplace transform on the zone II dimensionless diffusion equation to obtain a zone II dimensionless diffusion equation in the Laplace space;
performing dimensionless transform on a pressure function of fracture network zone II by the dimensionless transform relationship to obtain a dimensionless shale gas concentration when the gas supply from the matrix block to fracture network zone II reaches equilibrium;
substituting the dimensionless shale gas concentration into the zone II dimensionless diffusion equation in the Laplace space to obtain a matrix gas concentration of fracture network zone II;
obtaining a pseudo-steady-state diffusion seepage differential equation of fracture network zone II according to fracture network zone II's matrix gas concentration, gas flow mechanism and seepage differential equation;
performing dimensionless transform on the pseudo-steady-state diffusion seepage differential equation by the dimensionless transform relationship to obtain a differential equation of fracture network zone II;
performing Laplace transform on the zone II differential equation to obtain a zone II differential equation after the Laplace transform;
performing derivative finding on the solution of the zone IV diffusion equation;
using the solution of the zone IV diffusion equation after derivative founding to reduce the Laplace-transformed zone II differential equation to obtain a reduced zone II differential equation;
solving the reduced zone II differential equation to obtain a general solution of the reduced zone II differential equation;
performing derivative finding on the solution of the zone III diffusion equation;
obtaining a second preset condition;
performing derivative finding on the general solution in the second preset condition;
using the general solution in the second preset condition after the derivative finding to obtain an outer boundary condition of fracture network zone II, according to the solution of the zone III diffusion equation after derivative finding and a relationship between a fracture gas concentration and a pseudo-pressure;
obtaining an inner boundary condition of fracture network zone II; and
using the zone II outer boundary condition, the zone II inner boundary condition and the general solution in the second preset condition to obtain a solution of the zone II seepage differential equation.

6. The method for predicting the production of a fractured horizontal well in a shale gas reservoir according to claim 1, wherein the solving the zone I seepage differential equation by the dimensionless transform relationship, Laplace transform and the solution of the zone II seepage differential equation to obtain a solution of the zone I seepage differential equation specifically comprises:
performing dimensionless transform on the zone I seepage differential equation by the dimensionless transform relationship to obtain a zone I dimensionless seepage differential equation;
performing a calculus operation on the zone I dimensionless seepage differential equation to obtain a zone I dimensionless seepage differential equation after the calculus operation;
obtaining a continuous relationship of a gas flow flux at an interface between fracture network zone II and the hydraulically created fracture;
performing dimensionless transform on the zone I dimensionless seepage differential equation after calculus operation according to the continuous relationship of the gas flow flux and the dimensionless transform relationship, to obtain a reduced zone I seepage differential equation;
performing Laplace transform on the reduced zone I seepage differential equation to obtain a zone I seepage differential equation after the Laplace transform;
performing derivative finding on the solution of the zone II seepage differential equation;
obtaining a boundary condition of hydraulically fractured zone I; and
using the zone I boundary condition to solve the zone I seepage differential equation after the Laplace transform according to the solution of the zone II seepage differential equation after derivative finding, to obtain a solution of the zone I seepage differential equation.

7. The method for predicting the production of a fractured horizontal well in a shale gas reservoir according to claim 1, wherein the using the solution of the zone I seepage differential equation to obtain a bottom hole pseudo-pressure solution according to the first preset condition specifically comprises:
substituting the first preset condition into the solution of the zone I seepage differential equation to obtain a bottom hole pseudo-pressure solution.

8. A system for predicting the production of a fractured horizontal well in a shale gas reservoir, comprising:
a seepage zone dividing module, configured to divide a fractured horizontal well to be predicted in a shale gas reservoir into five seepage zones according to a matrix block and a fracture network after hydraulic fracturing, wherein the five seepage zones comprise: hydraulically fractured zone I, fracture network zone II, pure matrix zone III, pure matrix zone IV and pure matrix zone V;
a seepage zone equation obtaining module, configured to obtain a zone I seepage differential equation for hydraulically created fracture zone I, a zone II seepage differential equation and a zone II diffusion equation for fracture network zone II, a zone III diffusion equation for pure matrix zone III, a zone IV diffusion equation for pure matrix zone IV and a zone V diffusion equation for pure matrix zone V;
a dimensionless transform relationship obtaining module, configured to obtain a preset dimensionless transform relationship;
a zone V diffusion equation solving module, configured to solve the zone V diffusion equation by the dimensionless transform relationship and Laplace transform to obtain a solution of the zone V diffusion equation;
a zone IV diffusion equation solving module, configured to solve the zone IV diffusion equation by the dimensionless transform relationship and Laplace transform to obtain a solution of the zone IV diffusion equation;
a zone III diffusion equation solving module, configured to solve the zone III diffusion equation by the dimensionless transform relationship, Laplace transform and the solution of the zone V diffusion equation to obtain a solution of the zone III diffusion equation;
a zone II seepage differential equation solving module, configured to solve the zone II seepage differential equation by the dimensionless transform relationship, Laplace transform, the zone II diffusion equation, the solution of the zone IV diffusion equation and the solution of the zone III diffusion equation, to obtain a solution of the zone II seepage differential equation;
a zone I seepage differential equation solving module, configured to solve the zone I seepage differential equation by the dimensionless transform relationship, Laplace transform and the solution of the zone II seepage differential equation to obtain a solution of the zone I seepage differential equation;
a first preset condition obtaining module, configured to obtain a first preset condition;
a bottom hole pseudo-pressure solution obtaining module, configured to use the solution of the zone I seepage differential equation to obtain a bottom hole pseudo-pressure solution according to the first preset condition;
a dimensionless production solution obtaining module, configured to obtain a dimensionless production solution by Duhamel's Principle according to the bottom hole pseudo-pressure solution; and
a production predicting module, configured to predict the production of the fractured horizontal well in the shale gas reservoir by using a Stehfest numerical inversion method according to the dimensionless production solution.

9. The system for predicting the production of a fractured horizontal well in a shale gas reservoir according to claim 8, wherein the zone V diffusion equation solving module specifically comprises:
a zone V dimensionless transform unit, configured to perform dimensionless transform on the zone V diffusion equation by the dimensionless transform relationship to obtain a zone V dimensionless diffusion equation;
a zone V Laplace transform unit, configured to perform Laplace transform on the zone V dimensionless diffusion equation to obtain a zone V dimensionless diffusion equation in a Laplace space;
a zone V boundary condition obtaining unit, configured to obtain a boundary condition of pure matrix zone V; and
a zone V dimensionless diffusion equation solving unit, configured to use the zone V boundary condition to solve the zone V dimensionless diffusion equation in the Laplace space to obtain a solution of the zone V diffusion equation.

10. The system for predicting the production of a fractured horizontal well in a shale gas reservoir according to claim 8, wherein the zone IV diffusion equation solving module specifically comprises:
a zone IV dimensionless transform unit, configured to perform dimensionless transform on the zone IV diffusion equation by the dimensionless transform relationship to obtain a zone IV dimensionless diffusion equation;
a zone IV Laplace transform unit, configured to perform Laplace transform on the zone IV dimensionless diffusion equation to obtain a zone IV dimensionless diffusion equation in the Laplace space;
a zone IV boundary condition obtaining unit, configured to obtain a boundary condition of pure matrix zone IV; and
a zone IV dimensionless diffusion equation solving unit, configured to use the zone IV boundary condition to solve the zone IV dimensionless diffusion equation in the Laplace space to obtain a solution of the zone IV diffusion equation.
